(19) United States
(12) Patent Application Publication
(10) Pub. No.: US 2016/0299373 A1
(43) Pub. Date: Oct. 13, 2016

(54) HIGH-CONTRAST AND BISTABLE SCATTERING MODE LIQUID CRYSTAL LIGHT SHUTTERS

(71) Applicant: NATIONAL CENTRAL UNIVERSITY, TAOYUAN COUNTY (TW)

(72) Inventors: KO-TING CHENG, CHIAYI CITY (TW); PO-YI LEE, NEW TAIPEI CITY (TW); TIMOTHY DAVID WILKINSON, CAMBRIDGE (GB); MALIK MUHAMMAD QASIM, CAMBRIDGE (GB)

(21) Appl. No.: 14/682,161

(22) Filed: Apr. 9, 2015

(51) Int. Cl. G02F 1/1347; G02F 1/1337; G02F 1/133; G02F 1/1343

(52) U.S. Cl. CPC G02F 1/13476; G02F 1/13439; G02F 1/1337; G02F 1/13306; G02F 2001/133738

(57) ABSTRACT

The invention relates to a high-contrast and bistable scattering mode liquid crystal light shutter. The shutter comprises two substrates; two transparent electrode layers, arranged between two substrates and respectively contacted with each corresponding substrate; an intermediate layer, interposed between two transparent electrode layers, the intermediate layer includes a plurality of spacers and a plurality of azo-liquid-crystal-doped cholesteric liquid crystals doped with nematic liquid crystals and chiral azobenzene dopants; and two vertical alignment films, respectively coated between each transparent electrode layer and the intermediate layer; wherein a transmittance of the azo-liquid-crystal-doped cholesteric liquid crystals is changed after applying external voltage with different frequencies to the two transparent electrode layers to change the structure of the azo-liquid-crystal-doped cholesteric liquid crystals, and the azo-liquid-crystal-doped cholesteric liquid crystals are kept in a scattering mode or a transparent mode to reduce the energy consumption after removing the external voltage.

### BACKGROUND OF THE INVENTION

1. Field of the Invention

The present invention relates to a high-contrast and bistable scattering mode liquid crystal light shutters, and especially relates to applications of a Transparent/Scattering Smart Window. The liquid crystal light shutters may be in a scattering mode while applying an external low-frequency or direct-current voltage with a constant amplitude. And the scattering mode may be kept after removing the external voltage. The liquid crystal light shutters may be in a transparent mode wile applying an external high-frequency voltage. And the transparent mode may be kept after removing the external voltage. On the other hand, the selected frequency is lower and the amplitude of the voltage changed to the scattering mode is lower. The selected frequency is higher and the amplitude of the voltage changed to the transparent mode is lower. This may reduce energy consumption.

2. Description of Related Art

The liquid crystal of the light shutters is a material with flowability of liquid and determined alignment of crystal. Because the liquid crystal materials are the main material of the light shutters, the light shutters may be assembled by interposed the liquid crystal between two aligned glass substrates applied to liquid crystal display technology. The alignment may be changed by an external electric field and further the optical properties for light transmitting the liquid crystal layer may be also changed. The light modulation due to the external electric field is called photoelectric effect of liquid crystal. It may be formed various liquid crystal displays, such as a Twisted Nematic LCD (liquid crystal display), a super Twisted Nematic LCD, a TFT (thin-film transistor) LCD, and etc.

More and more liquid crystal scattered light shutters have been disclosed because of development of technologies and growths of the liquid crystal technology, such as using PDLC (polymer dispersed liquid crystals). It mainly uses UV lights or heating to make the liquid crystals and polymers result in phase separation and may be switched to a scattering mode or a transparent mode by applying an external voltage. In general, the transmittance of a scattered type light shutter may be changed by continuously applying the external voltage, but it may cause energy consumption. Another light shutter may use Cholesteric liquid crystals. It may be switched to a scattering mode, a transparent mode, and a reflective mode by applying an external voltage. But the voltage is relatively higher and the transmittance is unstable while switching modes. Please refer to TW patent No. 1439773, which is disclosed a reflective liquid crystal display device and manufacturing method thereof. It may comprise a first substrate, a second second substrate, a liquid crystal layer, a first alignment layer, and a second alignment layer. The first substrate and the second substrate are arranged oppositely. The liquid crystal layer is interposed between the first substrate and the second substrate. The liquid crystal layer includes a plurality of liquid crystals for providing parts of lights to be reflected and parts of light to be penetrated. The second alignment layer is arranged at an inner side of the first substrate facing to the second substrate for absorbing the lights, penetrated the liquid crystal layer and aligning the liquid crystals.

The above mentioned reflective liquid crystal display device and manufacturing method thereof, the characteristics is that the penetrating lights are absorbed by the black liquid crystal alignment layer to enhance contrast and color saturation and further to achieve the purpose of simplifying process. But the operation voltage is relatively higher and it is unstable to switch to the transparent mode or the scattering mode for the light shutter with large area. Therefore, the Cholesteric liquid crystals are not suitable for applying to the some applications, such as sky window, automobile glass, and projection screen.

In view of the foregoing circumstances, the inventor has invested a lot of time to study the relevant knowledge, compare the pros and cons, research and develop related products. After quite many experiments and tests, the “high-contrast and bistable scattering mode liquid crystal light shutters” of this invention is eventually launched to improve the foregoing shortcomings, to meet the public use.

### SUMMARY OF THE INVENTION

The main object of the present invention is to keep a scattering mode or a transparent mode after applying or removing an external voltage to reduce energy consumption and keep high contrast, low operation voltage, and be-stable property. As regards the prior art technology, the inventor has endeavored to achieve the foregoing purpose and feature. The present invention relates to a high-contrast and bistable scattering mode liquid crystal light shutter, which comprise two substrates; two transparent electrode layers, arranged between two substrates and respectively contacted with each corresponding substrate; an intermediate layer, interposed between two transparent electrode layers, the intermediate layer includes a plurality of spacers and a plurality of azo-liquid-crystal-doped cholesteric liquid crystals doped with nematic liquid crystals and chiral azobenzene dopants; and two vertical alignment films, respectively coated between each transparent electrode layer and the intermediate layer; wherein a transmittance of the azo-liquid-crystal-doped cholesteric liquid crystals is changed after applying external voltage with different frequencies to the two transparent electrode layers to change the structure of the azo-liquid-crystal-doped cholesteric liquid crystals, and the azo-liquid-crystal-doped cholesteric liquid crystals are kept in a scattering mode or a transparent mode to reduce the energy consumption after removing the external voltage.

In some embodiments, the shutters may further comprise an external low-frequency voltage electrically connected to the two transparent electrode layers.

In some embodiments, the shutters may further comprise an external high-frequency voltage electrically connected to the two transparent electrode layers.

In some embodiments, the shutters may further comprise an external direct-current voltage electrically connected to the two transparent electrode layers.

The various objectives and advantages of the present invention will be more readily understood from the following detailed description when read in conjunction with the appended drawing.

### BRIEF DESCRIPTION OF THE DRAWINGS

FIG. 1 is a cross-sectional view of a high-contrast and bistable scattering mode liquid crystal light shutter of the present invention;

FIG. 2 is a perspective view of the high-contrast and bistable scattering mode liquid crystal light shutter of the present invention while inputting a low-frequency voltage to be in a scattering mode;

FIG. 3 is an enlarged view of the high-contrast and bistable scattering mode liquid crystal light shutter of the present invention observed under a microscope after inputting the low-frequency voltage;

FIG. 4 is a perspective view of the high-contrast and bistable scattering mode liquid crystal light shutter of the present invention while inputting a high-frequency voltage to be in a transparent mode;

FIG. 5 is an enlarged view of the high-contrast and bistable scattering mode liquid crystal light shutter of the present invention observed under a microscope after inputting the high-frequency voltage;

FIG. 6 is a perspective view of the high-contrast and bistable scattering mode liquid crystal light shutter of the present invention while inputting a direct-current voltage to be in a scattering mode;

FIG. 7 is a distribution diagram of the high-contrast and bistable scattering mode liquid crystal light shutter of the present invention measured the transmittances by changing voltages with a constant frequency; and

FIG. 8 is a distribution diagram of the high-contrast and bistable scattering mode liquid crystal light shutter of the present invention measured the transmittances by changing frequencies with a constant voltage.

### DETAILED DESCRIPTION OF THE INVENTION

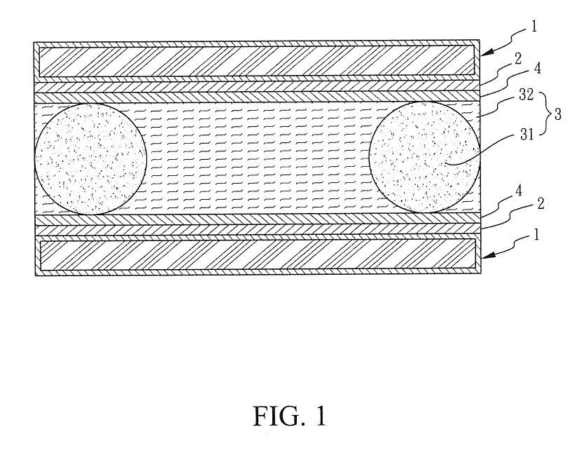

To describe clearly that the present invention achieves the foregoing objective and function, the technical features and desired function are described with reference to a preferred embodiment and accompanying drawings. Please reference to FIGS. 1 to 6, the present invention relates to a high-contrast and bistable scattering mode liquid crystal light shutter. The shutter may comprise two substrates 1; two transparent electrode layers 2, arranged between two substrates 1 and respectively contacted with each corresponding substrate 1; an intermediate layer 3, interposed between two transparent electrode layers 2, the intermediate layer 3 may include a plurality of spacers 31 and a plurality of azo-liquid-crystal-doped cholesteric liquid crystals 32 doped with nematic liquid crystals and chiral azobenzene dopants; and two vertical alignment films 4, respectively coated between each transparent electrode layer 2 and the intermediate layer 3; wherein a transmittance of the azo-liquid-crystal-doped cholesteric liquid crystals 32 is changed after applying external voltage with different frequencies to the two transparent electrode layers 2 to change the structure of the azo-liquid-crystal-doped cholesteric liquid crystals 32, and the azo-liquid-crystal-doped cholesteric liquid crystals are kept in a scattering mode or a transparent mode to reduce the energy consumption after removing the external voltage.

The materials of conventional liquid crystal shutters may use liquid crystals or liquid crystal doped with chiral dopants or polymers. However, they may be changed to a scattering mode and a transparent mode (the scattering mode and the transparent mode have been known in the art so that the descriptions are omitted) after applying an external voltage. But after removing the external voltage, the scattering mode or the transparent mode of the shutters may be not kept except continuously applying the external voltage. It will cause energy consumption. The azo-liquid-crystal-doped cholesteric liquid crystals 32 injected into the intermediate layer 3 and the chiral dopants providing a helical structure for the liquid crystals may make the nematic liquid crystal to the cholesteric liquid crystal. The chiral azobenzene dopants are the chiral dopants doped with Azobenzol. Azobenzol is the simplest azobenzenes. The parent structure of most azo dyes is that two phenyls are respectively connected to two ends of an azo (—N═N—).

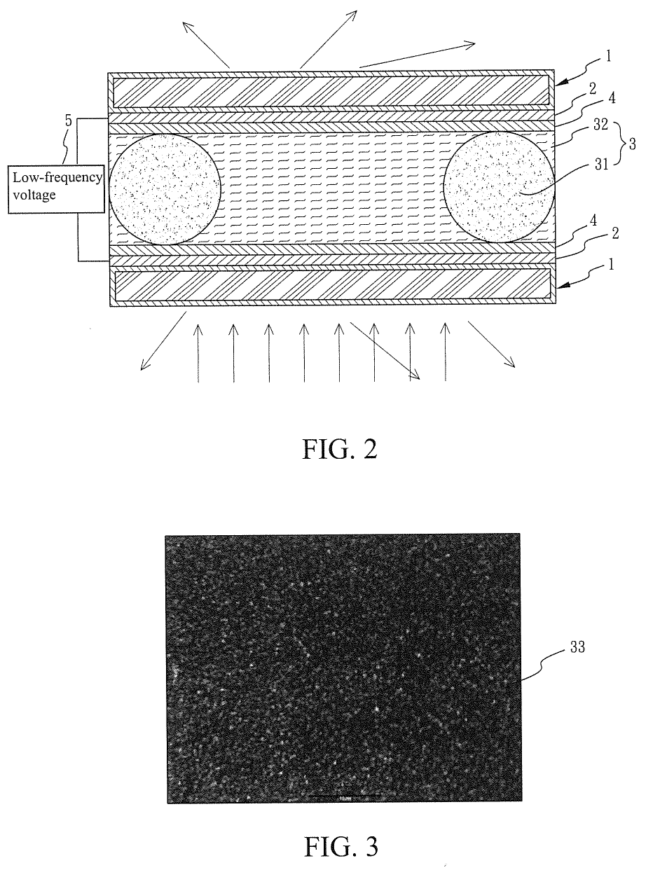

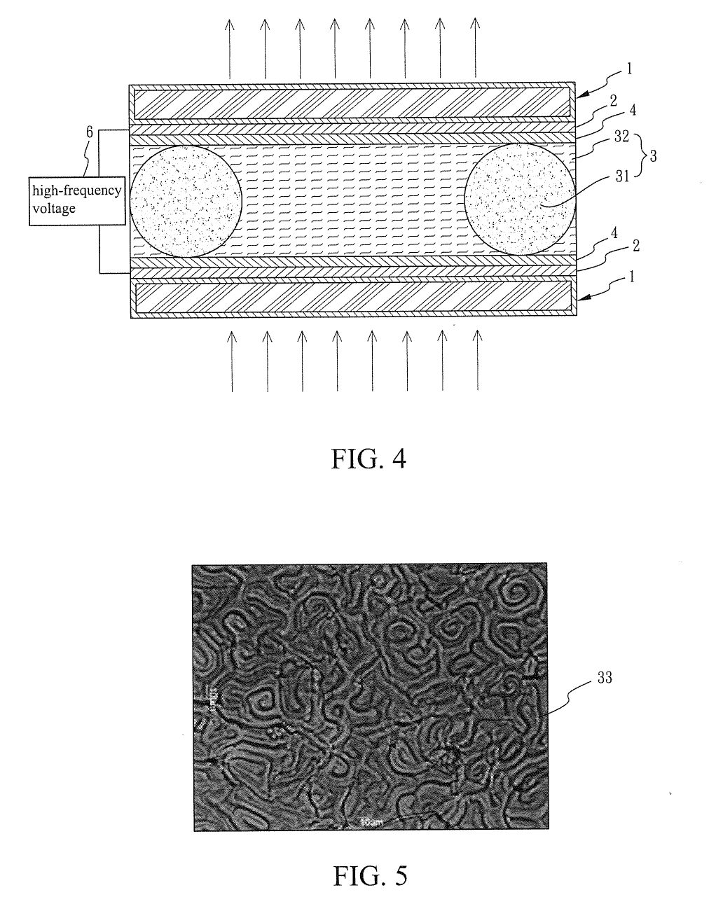

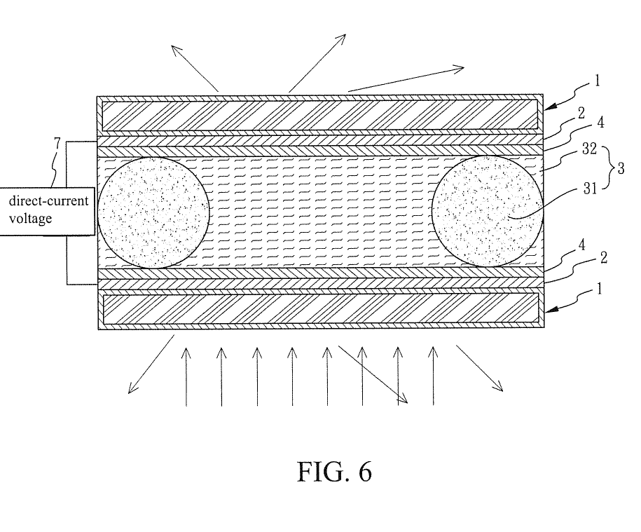

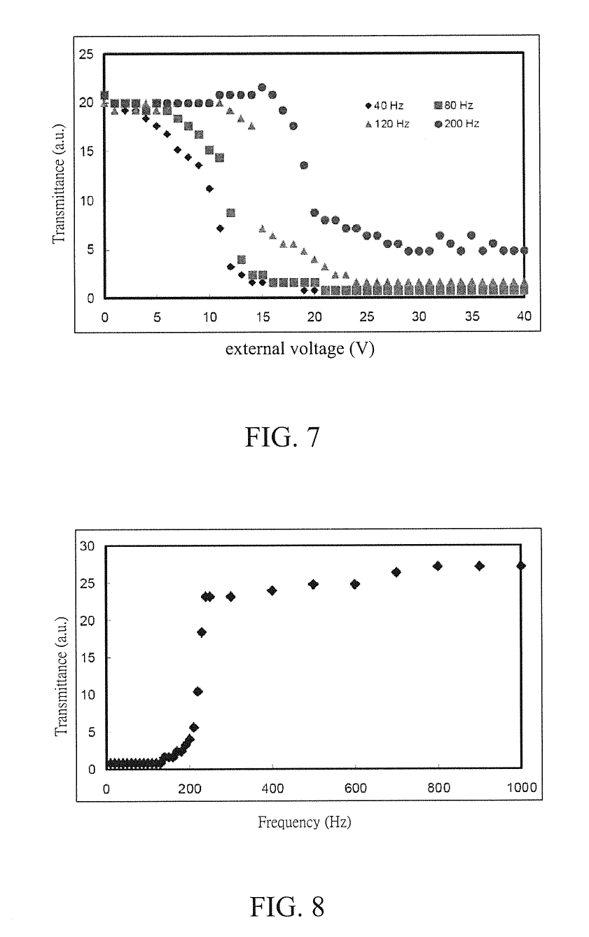

Continuously, the weight percentage of Azobenzol in the azo-liquid-crystal-doped cholesteric liquid crystals 32 is very low so that the spiral force of the chiral dopants is weak. Accordingly, an external low-frequency voltage 5 is electrically connected to the two transparent electrode layers 2 and the external low-frequency voltage 5 makes onside of the intermediate layer 3 change to cholesteric liquid crystal fingerprint textures 33. The spiral axes of the fingerprint textures 33 are different so as to perform many domains which are enough to scatter lights. Please reference to FIGS. 2 and 3, the visible lights may be scattered to perform the scattering mode. Besides the external low-frequency voltage 5, another embodiment further includes an external high-frequency voltage 6 for electrically connecting to the two transparent electrode layers 2. The scattering mode may be kept after the external low-frequency voltage 5 removes from the two transparent electrode layers 2. And the domains of the fingerprint textures 33 may be enlarged after removing the external low-frequency voltage 5 and then applying the external high-frequency voltage 6. The lights may be penetrated the substrates 1 directly to perform the transparent mode. Please reference to FIGS. 4 and 5, it will reduce energy consumption by doping with chiral azobenzene dopants. Please reference to FIG. 6, an external direct-current (DC) voltage 7 may be further applied to change the fingerprint textures 33 of the azo-liquid-crystal-doped cholesteric liquid crystals 32. The effect of the external direct-current (DC) voltage 7 is the same as the one of the external low-frequency voltage 5. In conclusion, the amplitudes of the external voltages may be kept constant and then the frequencies of the external voltages may be changed to switch to the transparent mode or the scattering mode of the shutters. That is, the shutters may be switched to the scattering mode by connecting the external low-frequency voltage 5 or the external DC voltage 7 to the two transparent electrode layers 2 and switched to the transparent mode by changing the low frequency to high frequency to become the high-frequency voltage 6. The frequency for switching is based on the amplitude of the external voltage. For example, please reference to FIGS. 6 and 7, the amplitude is 30V for constant, the frequency of the scattering mode is less than 200 Hz, and the transmittance is increased and the frequency is higher while the frequency is higher than 200 Hz. The frequency of the highest transmittance is 300 Hz.

Generally, when cholesteric liquid crystals are doped with chiral azobenzene, the optical activity of chiral azobenzene may be depressed through the photo isomerization of the chiral azobenzene to control UV exposure energies and then to perform different selective and reflective optical bands. Under the UV irradiation, the optical activity (trans-cis) of chiral azobenzene may change phase transfer of the cholesteric phase and the isotropic phase to result in penetration of light in optical phenomenon. It may achieve the effects of erasing with adding a heat source or applying an electric field. It may also include the effects of erasing and optical reading/writing. Because the vertical alignment liquid crystal films 4 has the azo-liquid-crystal-doped cholesteric liquid crystals 32 including negative liquid crystals doped with chiral dopants, the azo-liquid-crystal-doped cholesteric liquid crystals 32 may be kept in the scattering mode or the transparent mode to reduce energy consumption while applying or removing the external low-frequency voltage 5, the external DC voltage 7, or the external high-frequency voltage 6. Please reference to FIG. 7, the transmittance measured by different external voltages with a constant frequency. It obviously shows that the frequency of the external voltage is lower and the amplitude of the external voltage is lower so as to switch to the scattering mode. Please reference to FIG. 8, the transmittance measured by different frequencies corresponding to a constant voltage. It obviously shows that the frequency is higher and the transmittance is higher.

In addition, the two substrates 1 may be made by glass or plastics, but not limited thereto. The materials of the two transparent electrode layers 2 and spacers 31 are not limited. The vertical alignment films 4 may be replaced by materials for providing vertical alignment, such as polyimide vertical alignment film, DMOAP vertical alignment film, and the liquid crystals doped with nano-balls for providing spontaneous vertical alignment. The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

1. A high-contrast and bistable scattering mode liquid crystal light shutter, comprising:
two substrates;
two transparent electrode layers, arranged between two substrates and respectively contacted with each corresponding substrate, and the two transparent electrode layers are electrically connected to an external low-frequency voltage, an external high-frequency voltage, or an external direct-current voltage;
an intermediate layer, interposed between two transparent electrode layers, the intermediate layer includes a plurality of spacers and a plurality of azo-liquid-crystal-doped cholesteric liquid crystals doped with nematic liquid crystals and chiral azobenzene dopants; and
two vertical alignment films, respectively coated between each transparent electrode layer and the intermediate layer;
wherein a transmittance of the azo-liquid-crystal-doped cholesteric liquid crystals is changed after applying external voltage with different frequencies to the two transparent electrode layers to change the structure of the azo-liquid-crystal-doped cholesteric liquid crystals, and the azo-liquid-crystal-doped cholesteric liquid crystals are kept in a scattering mode or a transparent mode to reduce the energy consumption after removing the external voltage.

2-4. (canceled)
